(19) United States
(12) Patent Application Publication
(10) Pub. No.: US 2011/0032293 A1
(43) Pub. Date: Feb. 10, 2011

(54) Ink ejector, and ink ejection control method

(75) Inventors: Katsuhiro Yamamoto, Kitakatsuragi-gun (JP); Chiyoshi Yoshioka, Nara-shi (JP); Hidetsugu Kawai, Kashiba-shi (JP)

Correspondence Address: EDWARDS ANGELL PALMER & DODGE LLP, P.O. BOX 55874, BOSTON, MA, 02205, US

(73) Assignee: Sharp Kabushiki Kaisha, Abeno-ku, Osaka-shi, Osaka-shi (JP)

(21) Appl. No.: 12/310,932

(22) PCT Filed: Sep. 13, 2007
(86) PCT No.: PCT/JP2007/067814

§ 371 Date: Oct. 8, 2010

(30) Foreign Application Priority Data
Sep. 13, 2006 (JP) 2006-248556

(51) Int. Cl. B41J 29/38

(52) U.S. Cl. 347/10

(57) ABSTRACT

An ink ejector includes a head movement control section (22), an ink ejection area recognition section (3), an ink ejection timing control section (23), and an ink droplet number calculating section (5). With this arrangement, it is possible to cause nozzles included in a nozzle array to eject ink at different timings and gradually increase an amount of ink to be ejected. This allows a film thickness of an ink ejection area after landing of ink droplets to be uniform. As a result, it is possible to form a good-quality film. Further, since a head (7) includes a nozzle array having a plurality of nozzles (10), it is possible to shorten the amount of time required to restore a defective pixel. Thus, it is possible to provide an ink ejector and an ink ejection control method in which a good-quality film having a uniform thickness can be formed, and the amount of time required to restore a defective pixel can be shortened.

### TECHNICAL FIELD

The present invention relates to an ink ejector for ejecting ink to a medium with the use of a head including nozzles, and to a method for controlling the ink ejector. The present invention especially relates to an ink ejector and an ink ejection control method which can be suitably used, for example, in an application in which ink is speedily and accurately ejected to pixels on a color filter panel (Color Filter Panel, hereinafter referred to as “CF panel”) so that the ink is applied onto the pixels with high quality.

### BACKGROUND ART

In recent years, an ink ejection technique has been widely applied not only to a consumer printer, but also to a liquid crystal CF panel manufacturing apparatus or other manufacturing apparatuses, and expands in application. Examples include an inkjet patterning technique for forming a pattern on a substrate with the use of the ink ejection technique. According to the inkjet patterning technique, a minute amount of ink is ejected from an ink ejector so that a minute pattern is directly printed on a substrate. Instead of a conventional pattern formation method employing a vacuum process by photolithography, the inkjet patterning technique has been attracting attention as a technique which does not employ the vacuum technique.

Development of an ink ejector for forming a CF panel with the use of the inkjet patterning technique has been vigorously promoted. The ink ejector causes ink droplets of red (R), green (G), and blue (B) to be landed on R, G, and B pixel areas on a glass substrate, thereby filling R, G, and B pixels with the ink droplets, respectively. Thus, the CF panel is formed. The ink ejector is used, especially, in manufacturing a liquid crystal CF panel whose area size has been recently increased more than ever. Processing time of the ink ejector is strictly managed, and the ink ejector is required to complete processes within a predetermined short time period with accuracy. A particularly high-quality CF panel is further required when it is used in a liquid crystal television or the like.

Further, the inkjet patterning technique is widely used not only as a technique for printing entire pixels but also as a technique for restoring a defective pixel caused by mixture or adhesion of foreign substances. For example, in a case where a defective pixel is caused by mixture of ink colors between adjacent pixels, the defective pixel is restored as follows. Specifically, an ink layer of the defective pixel, having the mixture of ink colors, is removed with the use of a device such as a laser device, and ink of an intended color is ejected again to the ink layer thus removed, with the use of the inkjet patterning technique.

A Patent Literature 1 discloses a method for ejecting ink to a pixel so as to restore the pixel. According to the method, during restoration of a pixel, a same nozzle moves and ejects ink droplets so that the ink droplets partially overlap one another and so that a spacing between adjacent ink droplets in the first half of the ejection is greater than a spacing between adjacent ink droplets in the second half of the ejection. Specifically, as shown in FIG. 9, a spacing between B and C and a spacing between C and D (the first half of the ejection) are widened, and a spacing between D and E and a spacing between E and F (the second half of the ejection) are narrowed. This can prevent a phenomenon in which an ink droplet which is ejected later is drawn towards an adjacent ink droplet which has been ejected earlier.

### CITATION LIST

Patent Literature 1

Japanese Patent Application Publication, Tokukaihei, No. 8-327816 A (Publication Date: Dec. 13, 1996)

### SUMMARY OF INVENTION

However, the conventional ink ejector may eject ink to a pixel in a state where a head having a plurality of nozzles is tilted, while the head is being moved in a short side direction of the pixel as a printing direction of the pixel. This is because a large number of nozzles are allotted to the pixel. In this case, a film thickness of the pixel becomes uneven after landing of ink droplets because an ink droplet ejected by one nozzle which reaches the pixel later is drawn towards an ink droplet ejected by another nozzle which has reached the pixel earlier. This causes a problem that it is impossible to form a good-quality film.

Further, the method disclosed in the Patent Literature 1 is directed to a method for correcting a thickness of a pixel in a long side direction of the pixel in a case where a nozzle is moved in a long side direction of the pixel as the printing direction of the pixel. That is, the method disclosed in the Patent Literature 1 is directed to a method for correcting a thickness of a pixel in a moving direction of the nozzle. Therefore, in a case where a head having a plurality of nozzles is moved in a short side direction of a pixel, it is impossible to correct a thickness in a long side direction of the pixel.

Furthermore, a liquid crystal display device, including a CF panel manufactured with the use of an ink ejector employing the inkjet patterning technique, has been recently increased in size more than ever. In view of the circumstances, it is necessary to realize a good-quality image (i) by forming, on a substrate, a good-quality film having a uniform thickness and (ii) by accurately restoring a defective pixel while adjusting a position of the defective pixel. Furthermore, it is extremely important to shorten the amount of time required to eject ink to a defective pixel so that the defective pixel is restored.

The present invention was attained in view of the above problems. An object of the present invention is to provide an ink ejector and an ink ejection control method in which a good-quality film having a uniform thickness can be formed and the amount of time required to restore a defective pixel can be shortened.

As a result of diligent studies on the aforementioned object, the inventors of the present invention found out that, in order to form a good-quality film having a uniform thickness and shorten the amount of time required to restore a defective pixel, a direction in which a head is moved, an ink ejection timing, and an ink ejection amount can be controlled. Based on this finding, the inventors accomplished the present invention.

In order to attain the above object, an ink ejector of the present invention including a head which (i) is movable relative to a medium to which ink is to be ejected and (ii) includes a nozzle array having a plurality of nozzles from which ink can be ejected to the medium, includes: movement control means for controlling the head to be movable in a direction which is not parallel to the nozzle array; ejection nozzle determination means for determining an ejection nozzle group including a plurality of target nozzles which are successively arranged in the nozzle array and actually eject ink to the medium; ink ejection timing control means for controlling ink ejection so that ink ejection timing is delayed in an order in which the plurality of target nozzles in the ejecting nozzle group eject ink; and ink ejection amount control means for gradually changing an amount of ink to be ejected so that the amount of ink to be ejected is increased in the order in which the plurality of target nozzles in the ejecting nozzle group eject ink.

In order to attain the above object, an ink ejection control method of the present invention for controlling ink ejection from a head which (i) is movable relative to a medium to which ink is to be ejected and (ii) includes a nozzle array having a plurality of nozzles from which ink can be ejected to the medium, the head being movable in a direction which is not parallel to the nozzle array, includes the steps of: (a) determining an ejection nozzle group including a plurality of target nozzles which are successively arranged in the nozzle array and actually ejects ink to the medium; (b) controlling ink ejection so that an ink ejection timing is delayed in an order in which the plurality of target nozzles in the ejecting nozzle group eject ink; and (c) gradually changing an amount of ink to be ejected so that the amount of ink to be ejected is increased in the order in which the plurality of target nozzles in the ejecting nozzle group eject ink.

According to the above invention, the direction in which the head is moved is not parallel to the nozzle array provided in the head. This cause a time difference in ink ejection among the nozzles determined as the ink ejection nozzles. Therefore, it is possible to cause the nozzles included in a nozzle array to eject ink at different timings, and to gradually increase an amount of ink to be ejected. Since an amount of ink ejected later is larger than an amount of ink ejected earlier, a film thickness of an ink ejection area can be made uniform after landing of ink droplets even if the ink ejected later is drawn towards the ink ejected earlier. As a result, it is possible to form a good-quality film.

Further, according to the above invention, the head includes a nozzle array having a plurality of nozzles. Therefore, it is possible to shorten the amount of time required to restore a defective pixel. Furthermore, it is possible to reduce an amount of ink to be ejected from each of the plurality of nozzles.

Further, it is preferable that the ink ejector of the present invention further includes ink ejection area recognition means for recognizing an ink ejection area to which ink is to be actually ejected, wherein the ejection nozzle determination means determines, as the ejection nozzle group, a nozzle group including a plurality of nozzles corresponding to the ink ejection area thus recognized, the plurality of nozzles being included in the nozzle array, and the ink ejection timing control means and the ink ejection amount control means (i) determine, as a first nozzle which first eject ink, a nozzle which first reaches the ink ejection area and (ii) control the ejection timing and a change in amount of ink to be ejected, respectively, in an order in which the first nozzle and its following nozzles are arranged.

Further, it is preferable that the ink ejection control method of the present invention further includes (d) recognizing an ink ejection area to which ink is to be actually ejected, wherein: in the step (a), a nozzle group including a plurality of nozzles corresponding to the ink ejection area thus recognized is determined as the ejection nozzle group, the plurality of nozzles being included in the nozzle array, and in the step (b) and (c), (i) a nozzle which first reaches the ink ejection area is determined as a first nozzle which first ejects ink, (ii) the ejection timing and a change in amount of ink to be ejected are controlled, respectively, in an order in which the first nozzle and its following nozzles are arranged.

With this arrangement, it is possible to cause a time difference in arrival at an ink ejection area among the nozzle group allotted to the ink ejection area. Therefore, it is possible to cause the nozzles included in a nozzle array to eject ink at different timings, and to gradually increase an amount of ink to be ejected. That is, it is possible (i) to cause a nozzle which arrives at the ink ejection area earlier to eject a smaller amount of ink and (ii) to cause a nozzle which arrives at the ink ejection area later to eject a larger amount of ink.

Further, it is preferable that the ink ejector of the present invention is arranged such that the ink ejection area recognition means can recognize at least one of shape and size of the ink ejection area, and the ink ejection amount control means controls the change in amount of ink to be ejected on a basis of information thus recognized by the ink ejection area recognition means.

Further, it is preferable that the ink ejection control method of the present invention is arranged such that in the step (d), at least one of shape and size of the ink ejection area can be recognized, and in the step (c), the change in amount of ink to be ejected is controlled on a basis of information thus recognized by the ink ejection area recognition means.

With this arrangement, the film thickness of the ink ejection area can be made uniform after landing of ink droplets. As a result, it is possible to form a good-quality film.

Further, it is preferable that the ink ejector is arranged such that the ink ejection amount control means is an ink droplet number calculating section which changes an amount of ink droplets to be ejected so as to gradually change the amount of ink to be ejected.

Further, it is preferable that the ink ejection control method of the present invention is arranged such that the step (c) is a step (e) in which an amount of ink droplets to be ejected is changed so that the amount of ink to be ejected is gradually changed.

With this arrangement, it is possible to change, at an accurate ratio, an amount of ink to be ejected.

Further, it is preferable that the ink ejector of the present invention is arranged such that the movement control means controls the head or the medium to move in a direction tilted with respect to the nozzle array.

Further, it is preferable that the ink ejection control method of the present invention is arranged such that the head or the medium is movable in a direction tilted with respect to the nozzle array.

With this arrangement, it is possible to increase the number of nozzles which can be allotted to the ink ejection area, as compared with a case where the head or the medium is moved in a direction perpendicular to the nozzle array. As a result, it is possible to shorten the amount of time required to restore a defective pixel. Further, it is possible to correct the film thickness in the long side direction of the ink ejection area while the head or the medium is being moved in the short side direction of the ink ejection area. As a result, it is possible to shorten the amount of time required to restore a defective pixel, as compared with a case where the film thickness in the long side direction of the ink ejection area is corrected while the head or the medium is being moved in the long side direction of the ink ejection area.

Further, it is preferable that the ink ejector of the present invention further includes angle adjustment means for adjusting an angle of the head or the medium. Further, it is preferable that the ink ejector of the present invention is arranged such that the angle adjustment means adjusts the angle of the head or the medium with respect to the nozzle array on a basis of at least one of the shape and the size of the ink ejection area, and functions as the ejection nozzle determination means for determining, as the ejection nozzle group, a nozzle group including a plurality of nozzles corresponding to the ink ejection area on a basis of the angle thus adjusted.

Further, it is preferable that the ink ejection control method of the present invention further includes (f) adjusting an angle of the head or the medium. Further, it is preferable that the ink ejection control method of the present invention is arranged such that in the step (f), the angle of the head or the medium with respect to the nozzle array is adjusted on a basis of at least one of the shape and the size of the ink ejection area, and the step (f) functions as the step (a) of determining, as the ejection nozzle group, a nozzle group including a plurality of nozzles corresponding to the ink ejection area, on a basis of the angle thus adjusted.

With this arrangement, it is possible to control the number of nozzles to be allotted to the ink ejection area.

Further, it is preferable that the ink ejector of the present invention further includes ink ejection pattern generating means for generating an ink ejection pattern on a basis of at least (i) the angle of the head or the medium which angle is adjusted by the angle adjustment means and (ii) the gradual change in amount of ink to be ejected which change is controlled by the ink ejection amount control means, ink being ejected from the ejection nozzle group on a basis of the ink ejection pattern.

Further, it is preferable that the ink ejection control method of the present invention, further includes (g) generating an ink ejection pattern on a basis of at least (i) the angle of the head or the medium which angle is adjusted in the step (f) and (ii) the gradual change in amount of ink to be ejected which change is controlled in the step (c), ink being ejected from the ejection nozzle group on a basis of the ink ejection pattern.

With this arrangement, it is possible to control the ink ejection timing with the use of the generated ink ejection pattern.

Further, it is preferable that the ink ejector of the present invention is arranged such that the ink ejection timing control means controls the ink ejection timing to be delayed with a use of the ink ejection pattern generated by the ink ejection pattern generating means, and the head ejects ink in response to a control signal from the ink ejection timing control means and the ink ejection pattern.

Further, it is preferable that the ink ejection control method of the present invention is arranged such that in the step (b), the ink ejection timing is controlled to be delayed with a use of the ink ejection pattern generated in the step (g), and the head ejects ink in response to a control signal from the step (b) and the ink ejection pattern.

With this arrangement, it is possible to change, at an accurate ratio, the ink ejection timing and the ink ejection amount.

Further, it is preferable that the ink ejector of the present invention is arranged such that the ink ejector is used to restore a defective pixel of a color filter panel for use in a display device. Further, the ink ejector of the present invention is arranged such that the color filter panel is for use in a liquid crystal display device.

Further, it is preferable that the ink ejection control method of the present invention is arranged such that the ink ejection control method is used to restore a defective pixel of a color filter panel for use in a display device. Further, it is preferable that the ink ejection control method of the present invention is arranged such that the color filter panel is for use in a liquid crystal display device.

An especially good-quality CF panel is required when used in a liquid crystal display panel. According to the ink ejector and the ink ejection control method of the present invention, it is possible to form a good-quality film having a uniform thickness. Therefore, the ink ejector and the ink ejection control method of the present invention can be used for restoration of defective pixels on a CF panel for use in a liquid crystal display device.

For a fuller understanding of the nature and advantages of the invention, reference should be made to the ensuing detailed description taken in conjunction with the accompanying drawings.

### BRIEF DESCRIPTION OF DRAWINGS

FIG. 1

FIG. 1 is a block diagram showing a main part of an ink ejector of an embodiment of the present invention.

FIG. 2

FIG. 2 is a schematic view showing an arrangement of the ink ejector of the embodiment of the present invention.

FIG. 3

(a) and (b) of FIG. 3 are views each showing an outline of a head of the embodiment of the present invention. (a) of FIG. 3 is a view showing an outline of the head, which view is obtained when the head is viewed obliquely, and (b) of FIG. 3 is a view showing a cross section of the head and a cross section of a substrate on which a CF panel is formed.

FIG. 4

FIG. 4 is a plan view explaining an ink ejection method of the embodiment of the present invention.

FIG. 5

FIG. 5 is a cross-sectional view showing an ink thickness obtained after ink is ejected in accordance with the ink ejection method of the embodiment of the present invention.

FIG. 6

(a) and (b) of FIG. 6 are plan views each explaining an ink ejection method of the embodiment of the present invention. (a) of FIG. 6 shows a method in which an ink ejecting section moves upward, and (b) of FIG. 6 shows a method in which an ink ejecting section moves downward.

FIG. 7

FIG. 7 is a cross-sectional view showing an ink thickness obtained after ink is ejected in accordance with the ink ejection method of the embodiment of the present invention.

FIG. 8

FIG. 8 is a flow chart showing a main part of an ink ejection control method of the embodiment of the present invention.

FIG. 9

FIG. 9 is a plan view explaining an ink ejection method of the Patent Literature 1.

### REFERENCE SIGNS LIST

1 Ink ejector
2 Ink ejecting section
3 Ink ejection area recognition section (ink ejection area recognition means)
4 Ink ejection order determination section
5 Ink droplet number calculating section
6 Ink ejection pattern generating section (ink ejection pattern generating means)
7 Head
7R Head
7G Head
7B Head
8 Substrate
8a Filter layer
8b Glass layer
10 Nozzle
11 Housing
12 Nozzle plate
13 Ink ejection hole
14 Piezoelectric member
15 Ink flow path
16 Ink droplet
17 Defective pixel (ink ejection area)
18 Pixel boundary
21 Head angle control section (angle adjustment means)
22 Head movement control section (movement control means)
23 Ink ejection timing control section (ink ejection timing control means)

### DESCRIPTION OF EMBODIMENTS

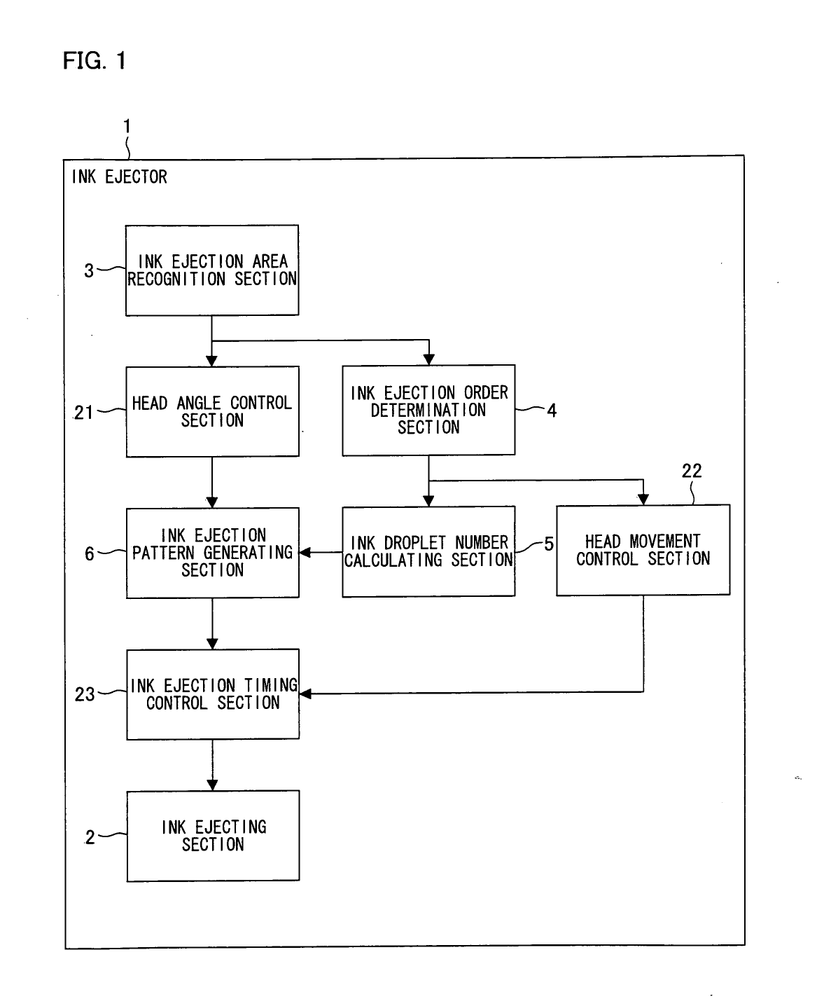

One embodiment of the present invention is described below with reference to FIGS. 1 through 8.

FIG. 1 shows an embodiment of the present invention, and is a block diagram showing a main part of an ink ejector 1. As shown in FIG. 1, the ink ejector 1 mainly includes an ink ejecting section 2, an ink ejection area recognition section (ink ejection area recognition means) 3, an ink ejection order determination section 4, an ink droplet number calculating section 5, an ink ejection pattern generating section (ink ejection pattern generating means) 6, a head angle control section (angle adjustment means) 21, a head movement control section (movement control means) 22, and an ink ejection timing control section (ink ejection timing control means) 23.

The ink ejecting section 2 ejects ink to a plurality of defective pixels generated on a CF panel. An arrangement of the ink ejecting section 2 is described later in detail.

The ink ejection area recognition section 3 recognizes shape and position of respective of the plurality of defective pixels generated on the CF panel. The ink ejection area recognition section 3 recognizes the shape and position of respective of the plurality of the defective pixels with the use of, for example, an image pickup section such as a camera for use in observation. Specifically, the ink ejection area recognition section 3 can recognize shape, size, and position of respective of the plurality of defective pixels spotted on a medium, with the actual use of an image pickup section. Alternatively, the ink ejection area recognition section 3 can recognize shape, size, and position of respective of the plurality of defective pixels by obtaining, as electronic data, information indicative of the shape, size, and position of the plurality of defective pixels which have been described in advance in a file or the like.

The ink ejection order determination section 4 determines an order in which the plurality of defective pixels should be restored on the basis of information, which has been recognized by the ink ejection area recognition section 3, such as the shape and position of respective of the plurality of the defective pixels. That is, the ink ejection order determination section 4 determines the order in which the plurality of defective pixels are restored so as to minimize a processing time by minimizing the number by which a head 7 (described later) is moved on the basis of the information such as the shape and position of respective of the plurality of the defective pixels. Furthermore, the ink ejection order determination section 4 also determines a direction in which the head 7 is moved.

The ink droplet number calculating section 5 determines an amount of ink droplets to be ejected from nozzles 10 of each of the defective pixels, on the basis of the order in which the defective pixels are restored and the direction (later described) in which the head 7 is moved, the order and directions being determined by the ink ejection order determination section 4. Specifically, the ink droplet number calculating section 5 determines an amount of ink droplets so that an amount of ink droplets is gradually increased or decreased in an order from an end nozzle 10 to the other end nozzle 10 of the nozzles 10 allotted to each of the defective pixels.

The ink ejection pattern generating section 6 generates an ink ejection pattern on the basis of (i) the shape and position of respective of the defective pixels which have been recognized by the ink ejection area recognition section 3, (ii) the order in which the defective pixels are restored and the direction (later described) in which the head 7 is moved, the order and direction being determined by the ink ejection order determination section 4, and (iii) the amount of ink droplets which has been determined by the ink droplet number calculating section 5. Furthermore, the ink ejection pattern generating section 6 supplies, as an ink ejection timing signal, the ink ejection pattern thus generated to the ink ejecting section 2. Each of the nozzles 10 of the ink ejecting section 2 eject ink to the plurality of the defective pixels in response to the ink ejection timing signal thus supplied from the ink ejection pattern generating section 6.

The head angle control section 21 calculates an angle of a nozzle array (later described) provided in the head 7 on the basis of the shape and position of respective of the defective pixels which have been recognized by the ink ejection area recognition section 3 so as to change the angle of the nozzle array provided in the head 7. More specifically, the ink ejection pattern generating section 6 generates an ink ejection pattern on the basis of (i) the shape and position of respective of the plurality of the defective pixels which have been recognized by the ink ejection area recognition section 3, (ii) the order in which the defective pixels are restored and the direction (later described) in which the head 7 is moved, the order and the direction being determined by the ink ejection order determination section 4, (iii) the amount of ink droplets which has been determined by the ink droplet number calculating section 5, and (iv) the angle of the nozzle array provided in the head 7, which has been determined by the head angle control section 21.

The following circumstances are assumed as to the angle of the nozzle array provided in the head 7. Note that “the angle of the nozzle array provided in the head 7” refers to an angle in a direction in which the head 7 is moved.

In a case where the angle of the nozzle array provided in the head 7 is large, for example, in a case where the angle of the nozzle array provided in the head 7 is 45° or greater, (i) a printing width between adjacent nozzles becomes larger and (ii) the number of nozzles to be allotted to each of defective pixels becomes smaller, as compared with a case where the angle of the nozzle array provided in the head 7 is small. As such, it is possible to secure an amount of ink required for filling in the defective pixels, by taking one of the following measures (i) and (ii): (i) the head 7 is moved at a low speed so that it takes a long time for the head 7 to go over each of the defective pixels, or (ii) an applied voltage or the like is controlled so that the ink ejecting section 2 ejects large ink droplets. Meanwhile, since a printing width between nozzles at both ends becomes larger, it is also possible to fill a large defective pixel with ink, by using, as the restoration of a defective pixel, the nozzles at both ends.

On the other hand, in a case where the angle of the nozzle array provided in the head 7 is small, (i) a printing width between adjacent nozzles becomes smaller and (ii) the number of nozzles to be allotted to each of defective pixels becomes larger, as compared with a case where the angle of the nozzle array provided in the head 7 is large. Therefore, even if the head 7 is moved at a high speed so that it takes a shorter time for the head 7 to go over each of the defective pixels, it is possible to secure an amount of ink necessary for filling up the defective pixels. Meanwhile, since a printing width between nozzles at both ends becomes smaller, it is not possible to allot nozzles to a large defective pixel even when the nozzles at both ends are used. Therefore, in a case where a sufficient spread (wettability) of ink cannot be secured during the filling of a defective pixel with ink, it becomes impossible to fill a large defective pixel with ink.

Therefore, a suitable angle of the nozzle array provided in the head 7 varies mainly depending on a size of a defective pixel. That is, in a case where a defective pixel is small, it is preferable that the angle of the nozzle array is small so that a large number of nozzles can be allotted to the defective pixel.

On the other hand, in a case where a defective pixel is large, it is preferable that the angle of the nozzle array is large so that nozzles can be allotted to even end parts of the defective pixel, depending on a spread (wettability) of ink during the filling of the defective pixel with ink.

The head movement control section 22 causes the head 7 to move on the basis of the order in which the defective pixels are restored and the direction (later described) in which the head 7 is moved which have been determined by the ink ejection order determination section 4.

When the head 7 (later described) is moved by the head movement control section 22 so as to reach a defective pixel, the ink ejection timing control section 23 supplies an ink ejection timing signal to the ink ejection section 2 on the basis of the ink ejection pattern generated by the ink ejection pattern generating section 6. Each of the nozzles 10 of the ink ejecting section 2 ejects ink to a plurality of defective pixels in response to the ink ejection timing signal supplied from the ink ejection timing control section 23.

For example, the ink ejecting section 2 is arranged so as to eject ink when a count number of an encoder signal supplied from the ink ejection timing control section 23 reaches a predetermined number. Specifically, the ink ejection timing control section 23 first converts a position of a defective pixel into information indicative of a count number of the encoder signal. Next, the ink ejection timing control section 23 supplies the information thus converted to the ink ejecting section 2 before the head 7 moves. Then, the head 7 starts moving. Finally, the ink ejecting section 2 starts ejecting ink when the count number of the encoder signal supplied from the ink ejection timing control section 23 reaches a predetermined number.

Note that another arrangement is possible in which the ink ejection timing control section 23 outputs a timing signal to a comparator and a control section including, a CPU (Central Processing Unit). Here, the comparator converts the timing signal into a gate signal, and supplies the gate signal as a detection signal to the CPU. Then, the CPU can discriminate the detection signal supplied from the comparator. Each of the nozzles 10 of the ink ejecting section 2 ejects ink to a plurality of defective pixels on the basis of a result discriminated by the CPU.

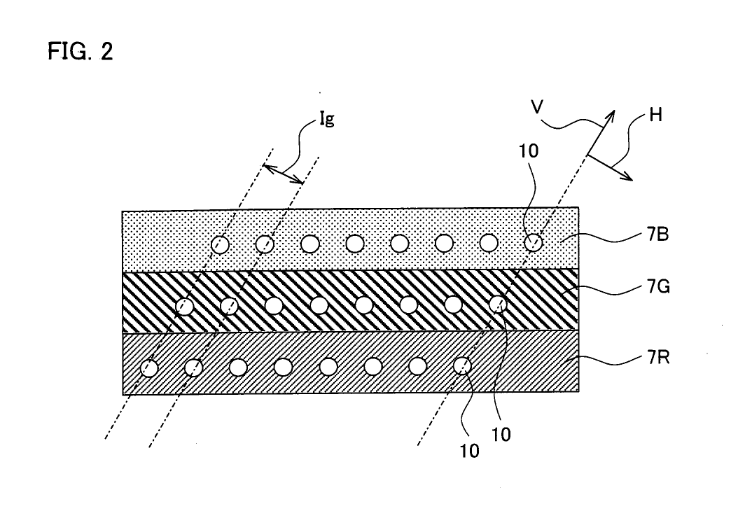

FIG. 2 is a view schematically illustrating an arrangement of the ink ejecting section 2. The ink ejecting section 2 has three heads 7 (head 7R, head 7G, head 7B) which correspond to red (R), green (G), and Blue (B), respectively. Each of the heads 7 includes a plurality of nozzles 10. Note that, in the present embodiment, the ink ejecting section 2 can have only one or two of the three heads 7. Note also that it is not necessary for the heads 7 to be parallel to nozzle arrays provided therein, respectively.

The arrays of nozzles 10 in the head 7R, the head 7G, and the head 7B are provided in an echelon form, respectively. This allows (i) a nozzle 10 at one end of the head 7R, a nozzle 10 at one end of the head 7G, and a nozzle 10 at one end of the head 7B and (ii) a nozzle 10 at the other end of the head 7R, a nozzle 10 at the other end of the head 7G, and a nozzle 10 at the other end of the head 7B to be aligned in the same direction as a main direction in which each of the heads 7 is moved, in a case where each of the heads 7 is rotated in an anticlockwise direction so as to be tilted in the main direction. Note that (i) the nozzle 10 at one end of the head 7R, the nozzle 10 at one end of the head 7G, and the nozzle 10 at one end of the head 7B and (ii) the nozzle 10 at the other end of the head 7R, the nozzle 10 at the other end of the head 7G, and the nozzle 10 at the other end of the head 7B are not necessarily aligned in the same direction as the main direction in which each of the heads 7 is moved. A tilt of each of the heads 7 in the main direction can be adjusted in accordance with the shape and position of respective of defective pixels.

As shown in FIG. 2, in a case where each of the heads 7 is tilted in the main direction (V direction in FIG. 2) or in a sub direction (H direction in FIG. 2), a spacing (Ig in FIG. 2) between ink ejected from adjacent nozzles 10 is smaller as compared with a case where each of the heads 7 is not tilted in the main direction or the sub direction. That is, in a case where each of the heads 7 is not tilted in the main direction (V direction) or in the sub direction (H direction), a spacing (Ig) between ink ejected from adjacent nozzles 10 is the same as a spacing between adjacent nozzles 10 in each of the heads 7. In contrast, in a case where each of the heads 7 is tilted in the main direction (V direction) or in the sub direction (H direction), a spacing (Ig) between ink ejected from adjacent nozzles 10 is smaller than a spacing between adjacent nozzles 10 in each of the heads 7. This allows a larger number of nozzles to be allotted to each of the defective pixels. As a result, it is possible to reduce an amount of ink to be ejected from each of the nozzles 10 thus allotted. Therefore, even in a case where the ink ejecting section 2 is moved at a high speed, it is possible to eject a predetermined amount of ink droplets to each of the defective pixels while the ejecting section 2 is being moved. Therefore, it is desirable that each of the heads 7 is tilted in the main direction or in the sub direction in accordance with shape and position of respective of the defective pixels.

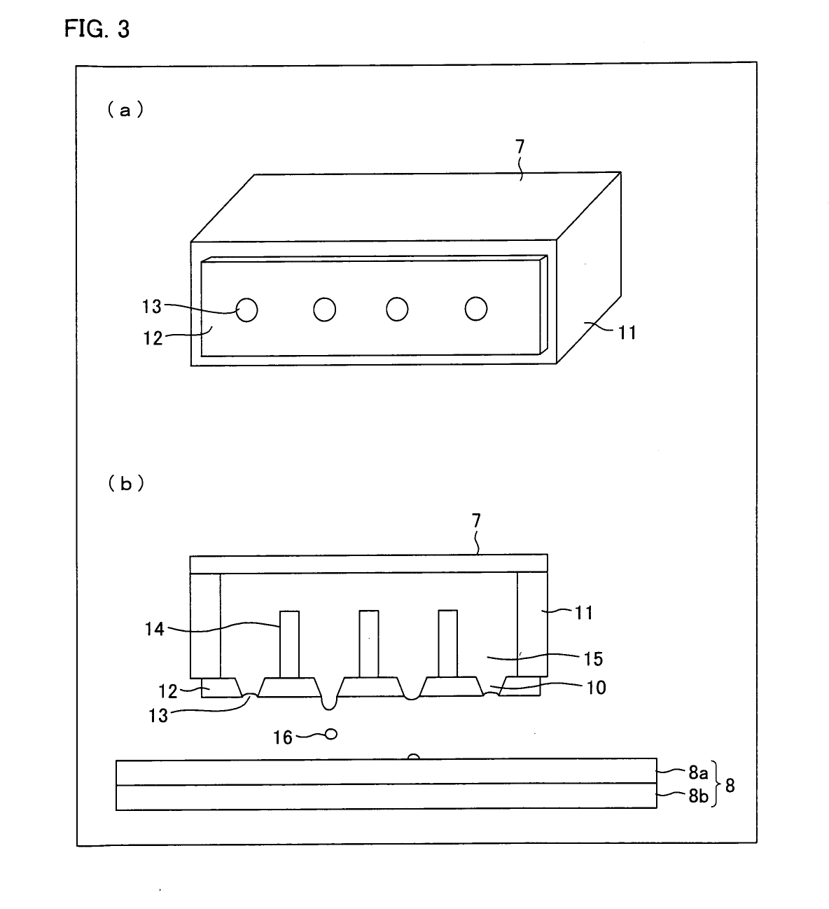

(a) of FIG. 3 illustrates an outline of the head 7, and (b) of FIG. 3 illustrates a cross section of the head 7 and a cross section of a substrate 8 (CF panel) to which ink is ejected from each nozzle 10 of the head 7. The substrate 8 (CF panel) is constituted by two layers, i.e., a filter layer 8a and a glass layer 8b.

As shown in (a) and (b) of FIG. 3, the head 7 includes the nozzles 10, a housing 11, a nozzle plate 12, ink ejection holes 13, and piezoelectric members 14. The head 7 contains ink. Note that for convenience of explanation, (b) of FIG. 3 shows four nozzles 10 which do not correspond to the number of the nozzles 10 of FIG. 2.

Specifically, an opening of the housing 11 is covered by the nozzle plate 12. The nozzle plate 12 is provided with the nozzles 10 at predetermined intervals. Each of the nozzles 10 is provided with an ink ejection hole 13 having a diameter of approximately 20 μm. The piezoelectric members 14 are provided in the housing 11 so that ink flow paths 15 are formed. Ink is ejected from each of the nozzles 10 to the substrate 8 as follows: the piezoelectric members 14 vibrate in accordance with an applied voltage, so that ink droplets 16 are ejected from the nozzles 10 toward the substrate 8, via the ink flow path 15.

Successive inkjet operations may cause a nozzle to be turned into a defective nozzle. This is partly because a head and/or ink change over time. The term “defective nozzle” as used herein refers to (i) a nozzle which is in a condition where it cannot eject ink, for example, due to entry of foreign substances into the nozzle, or (ii) a nozzle which is in an unstable condition where the ink is ejected with an ink landing accuracy beyond a specified range. In either case, a recovery operation such as priming or wiping is generally carried out so that a nozzle can eject ink stably.

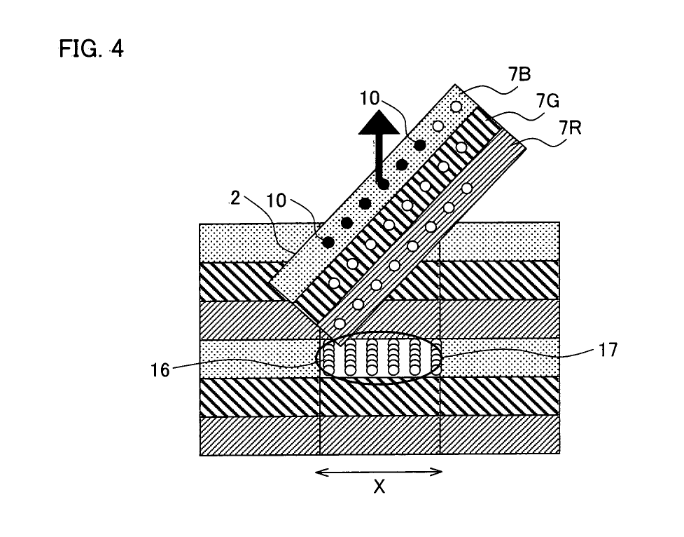

FIG. 4 is a plan view explaining how ink is ejected in a case where the ink ejecting section 2 carries out a restoration process with respect to a defective pixel. In FIG. 4, the ink ejecting section 2 shown in FIG. 2 moves in a short side direction of pixels on the CF panel (in an upward direction of FIG. 4) while being tilted with respect to the pixels on the CF panel.

In FIG. 4, a defective pixel (ink ejection area) 17 is a defective pixel of blue (B) which is generated in the CF panel. Ink is ejected to the defective pixel 17 with the use of the head 7B for blue. Specifically, ink droplets 16 are ejected, at constant time intervals, to the defective pixel 17 from a plurality of nozzles 10 out of array of nozzles 10 in the head 7B for blue, the plurality of nozzles 10 being allotted to a width X in a long side direction of the defective pixel 17.

As shown in FIG. 4, three-color ink, i.e., red (R) ink, green (G) ink, and blue (B) ink which respectively correspond to colors of the pixels of the CF panel are used. The heads 7R, 7G, and 7B are arranged as follows. The heads 7R, 7G, and 7B are (i) separately provided in the ink ejecting section 2 so that the red ink, green ink and blue ink are not mixed with one another within the ink ejecting section 2 and (ii) can control ink ejection independently of one another. Further, each of the pixels has a substantially rectangular shape. Since an inside area of each pixel is filled with ink, the inside area is subjected to a hydrophilic treatment so as to have good wettability and spread property with respect to ink, whereas a perimeter of each pixel is subjected to a water-repellent treatment so that no mixture of ink occurs between adjacent pixels, thereby causing a separation of the adjacent pixels.

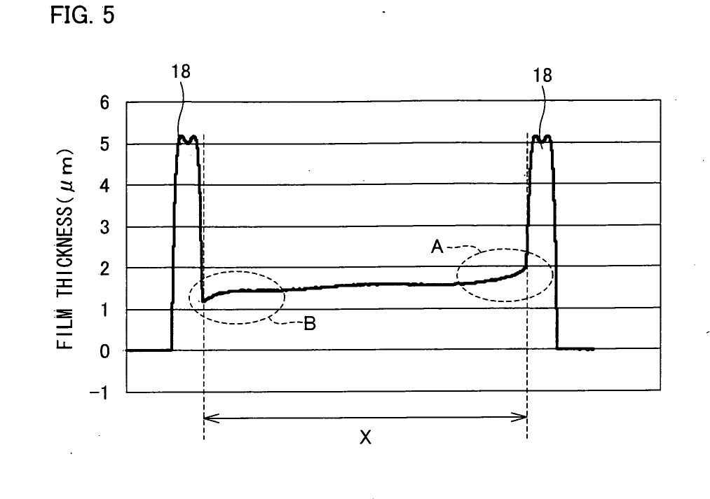

FIG. 5 is a cross-sectional view showing what an ink thickness in a long side direction of the defective pixel 17 looks like after a few seconds have passed since the ink ejecting section 2 ejected ink to the defective pixel 17 in FIG. 4. In FIG. 5, the horizontal axis indicates a relative position in the long side direction of the defective pixel 17, and the vertical axis indicates the ink thickness. Further, adjacent pixels are separated from each other by a pixel boundary 18.

As shown in FIG. 5, the section A to which ink is ejected earlier from the ink ejecting section 2 which is being moved in the short side direction of pixels has a large ink thickness, whereas, the section B to which ink is ejected later has a small ink thickness. That is, a time difference in ink ejection causes ink ejected later to be drawn towards ink ejected earlier. This causes a problem that an ink thickness becomes uneven within a pixel. Specifically, a difference of ±10% is generated in thickness between the section A and the section B.

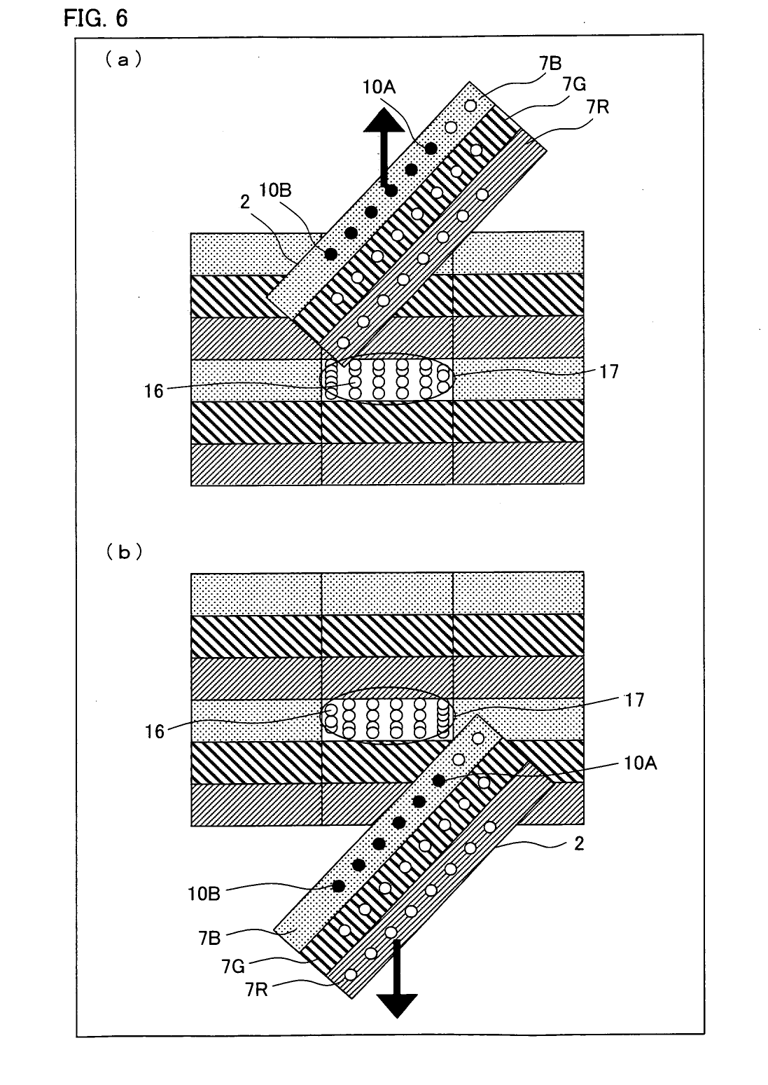

It would appear that the above problem can be solved by an ink ejection method shown in (a) and (b) of FIG. 6. (a) and (b) of FIG. 6 are plan views each explaining how ink is ejected in a case where the ink ejecting section 2 carries out a restoration process with respect to a defective pixel 17 (as well as FIG. 4). In the ink ejection method shown in FIG. 4, the number of ink droplets ejected from each nozzle 10 of the ink ejecting section 2 is fixed, whereas, in the ink ejection method shown in (a) and (b) of FIG. 6, the number of ink droplets ejected from one end nozzle 10A is reduced or increased and the number of ink droplets ejected from the other end nozzle 10B is increased or reduced, respectively. Note that the nozzles provided from the one end nozzle 10A to the other end nozzle 10B are allotted to the width X in the long side direction of the defective pixel 17.

The following description deals with the ink ejection method shown in (a) and (b) of FIG. 6 in detail. (a) of FIG. 6 shows a state in which the ink ejecting section 2 tilted with respect to the defective pixel 17 eject ink so as to restore the defective pixel 17 while being moved in the upward direction of (a) of FIG. 6 (in the short side direction of the pixels on the CF panel). In (a) of FIG. 6, of the nozzles 10 in the ink ejecting section 2, the nozzle 10A is the first one which goes over the defective pixel 17 and the nozzle 10B is the last one which goes over the defective pixel 17. Further, the nozzles provided from the nozzle 10A to the nozzle 10B indicate the plurality of nozzles allotted to the width X in the long side direction of the defective pixel 17.

The number of ink droplets ejected from each nozzle 10 is gradually increased, for example, as follows: six droplets are ejected from the nozzle 10A which is the first one going over the defective pixel 17; nine droplets are ejected from each of the nozzles 10 located between the nozzle 10A and the nozzle 10B; and eleven droplets are ejected from the nozzle 10B which is the last one going over the defective pixel 17.

(b) of FIG. 6 shows a state in which the ink ejecting section 2 tilted with respect to the defective pixel 17 ejects ink to the defective pixel 17 so as to restore the defective pixel 17 while being moved in a direction opposite to the direction shown in (a) of FIG. 6 (i.e. in a downward direction shown in (b) of FIG. 6 (short side direction of the pixels on the CF panel)). In (b) of FIG. 6, out of the nozzles 10 in the ink ejecting section 2 the nozzle 10B is the first one which goes over the defective pixel 17 and the nozzle 10A is the last one which goes over the defective pixel 17. Further, the nozzles provided from the nozzle 10B to the nozzle 10A indicate the plurality of nozzles allotted to the width X in the long side direction of the defective pixel 17.

The number of ink droplets ejected from each nozzle 10 is gradually increased, for example, as follows: six droplets are ejected from the nozzle 10B which is the first one going over the defective pixel 17; nine droplets are ejected from each of the nozzles 10 located between the nozzle 10B and the nozzle 10A; and eleven droplets are ejected from the nozzle 10A which is the last one going over the defective pixel 17.

The present embodiment deals with the case where the number of ink droplets ejected from each nozzle 10 is increased so that an amount of ink droplets ejected from each nozzle 10 can be increased. However, the present embodiment is not limited to this. For example, it is possible that the number of ink droplets ejected from each nozzle 10 is fixed and an amount per one ink droplet is increased so that an amount of ink droplets ejected from each nozzle 10 can be increased.

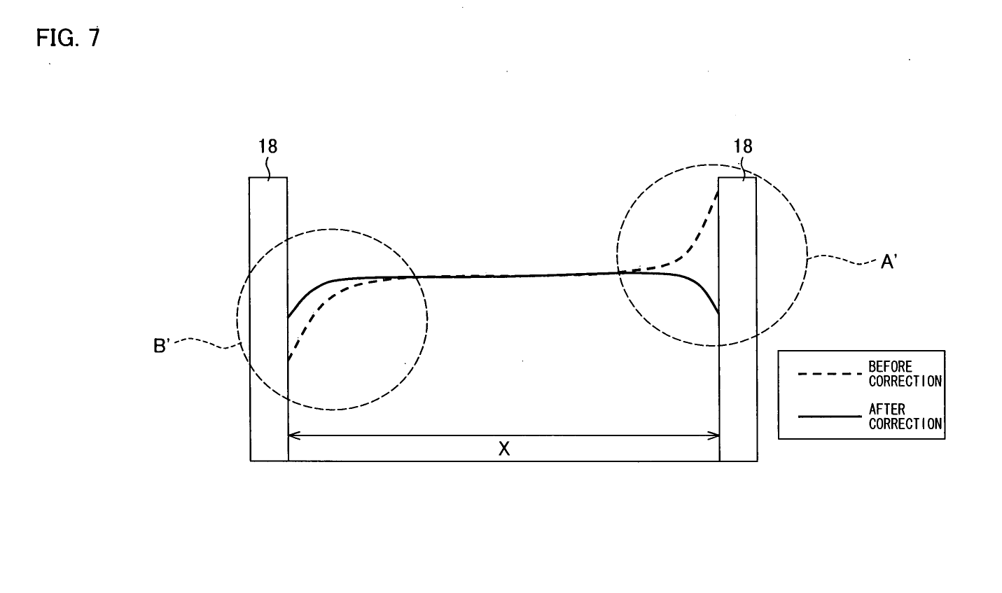

FIG. 7 is a cross-sectional view showing what an ink thickness in the long side direction of the defective pixel 17 looks like after a few seconds have passed since the ink ejecting section 2 ejected ink to the defective pixel 17 in (a) and (b) of FIG. 6. FIG. 7 shows the ink thickness obtained before and after the thickness correction is carried out. As in FIG. 5, in FIG. 7, the horizontal axis indicates a relative position in the long side direction of the defective pixel 17, and the vertical axis indicates the ink thickness. Further, adjacent pixels are separated from each other by the pixel boundary 18.

As is clear from FIG. 7, the unevenness of the ink thickness is considerably reduced in a case where the number of ink droplets ejected from the ink ejecting section 2, moving in the short side direction of the pixels, is gradually increased in an order in which the nozzles are located closer to the nozzle which is the last nozzle going over the defective pixel 17. That is, a section A′ to which ink is ejected earlier in the defective pixel 17 has a large ink thickness before the correction, but does not have a large ink thickness any more after the correction. Further, a section B′ to which ink is ejected later in the defective pixel 17 has a small ink thickness before the correction, but has a reduced degree of smallness of the ink thickness after the correction. As a result, a variation in ink thickness between the section A′ and the section B′ is reduced considerably.

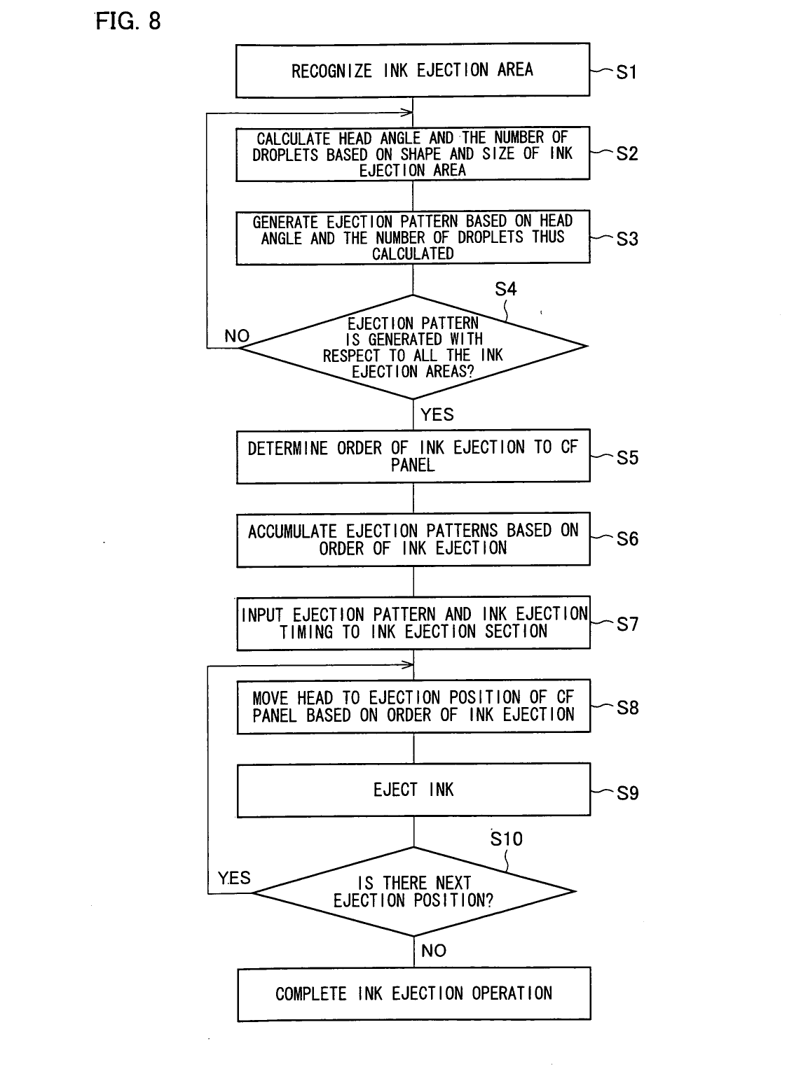

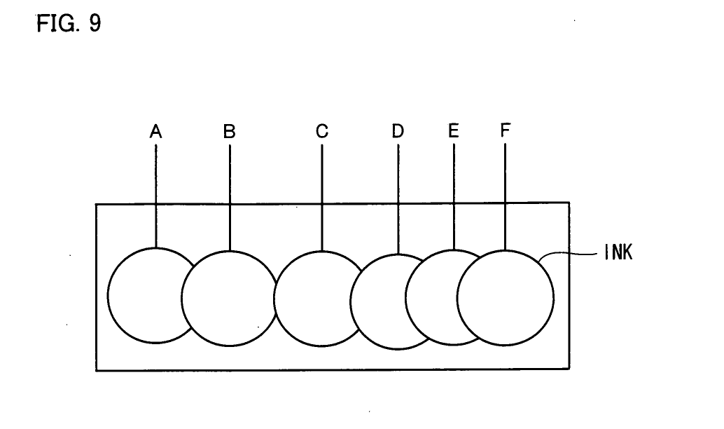

The following description deals with an ink ejection control method of the present invention with reference to a flowchart of FIG. 8.

Ink ejection areas are recognized (Step 1).

A head angle and the number of droplets to be ejected are calculated based on at least one of shape and size of each of the ink ejection areas (Step 2).

An ejection pattern is generated based on the head angle and the number of droplets thus calculated (Step 3).

It is determined whether or not ejection patterns have been generated with respect to the ink ejection areas, respectively (Step 4). In a case where it is determined that the ejection patterns have been generated with respect to the ink ejection areas, respectively (YES at Step 4), the process in Step 5 (below described) will be carried out. On the other hand, in a case where it is determined that the ejection patterns have not yet been generated with respect to the ink ejection areas, respectively (NO at Step 4), the process in the Step 2 will be carried out again.

An order of ink ejection to the CF panel is determined (Step 5).

The ejection patterns are accumulated based on the order of ink ejection (Step 6).

The ejection patterns and their ink ejection timing are supplied to the ink ejecting section (Step 7).

A head moves to an ejection position above the CF panel on the basis of the order of ink ejection (Step 8).

Ink is ejected (Step 9).

It is determined whether or not there is a next ejection position (Step 10). In a case where it is determined that there is a next ejection position (YES at Step 10), the process in the Step 8 is carried out again. In a case where it is determined that there is no next ejection position (NO at Step 10), an ink ejection operation is completed.

As described above, in a case where an ink ejector of the present embodiment is adopted, it is possible to appropriately set an amount of ink droplets to be ejected. As a result, it is possible to (i) manufacture a CF panel whose pixels are vivid and have no color unevenness and (ii) shorten a restoration time of a defective pixel(s).

The above-mentioned embodiment has dealt with an example in which the present invention is applied to restoration of a defective pixel generated on a CF panel. However, the present invention is not limited to this. The present invention can be also applied to manufacturing of an electroluminescence (EL) display device having a plurality of sections to which ink is ejected and which are arranged in a matrix manner or in a stripe manner. Further, the present invention can be applied to (i) manufacturing of a back substrate of a plasma display device, (ii) manufacturing of an image display device including an electron emitting element, and (iii) manufacturing of wiring.

The present embodiment has discussed a case where the ink ejector 1 includes the head movement control section 22. However, the ink ejector 1 can include a medium movement control section instead of the head movement control section 22. That is, the ink ejector 1 can be arranged such that a medium is movable. In such a case, the ink ejector 1 has the same arrangement as that of the above-mentioned embodiment except that the medium movement control section is used instead of the head movement control section 22. The drawings of the embodiment are properly referred to.

As described above, an arrangement of an ink ejector and an ink ejection control method of the present invention is not limited to a specific one, provided that the ink ejector has means for relatively moving a head or a medium, the head or a nozzle array being tilted with respect to a direction in which the ink ejector is moved, and has ejection means for gradually increasing or reducing an amount of ink to be ejected in an order from a nozzle at one end towards a nozzle at the other end.

Further, for example, the ink ejector and the ink ejection control method of the present invention may be arranged such that the medium is a substrate; the ink ejector ejects ink onto the substrate at a predetermined region having a substantially rectangular shape; and a longitudinal direction of the predetermined region is perpendicular to the direction in which the ink ejector is moved.

Further, for example, the ink ejector and the ink ejection control method of the present invention may be arranged such that the ink ejector has ejection means for reducing an amount of ink to be ejected from a nozzle which reaches the predetermined area earlier and increasing an amount of ink to be ejected from a nozzle which reaches the predetermined area later, among the tilted nozzle array allotted to the width in the longitudinal direction of the predetermined region.

Further, for example, the ink ejector and the ink ejection control method of the present invention may be arranged such that an angle of the head or the nozzle array with respect to the direction in which the substrate is moved is adjusted in accordance with a length of the predetermined region in the longitudinal direction of the predetermined region.

Further, for example, the ink ejector and the ink ejection control method of the present invention may be arranged such that the substrate is a CF panel for use in a liquid crystal display device.

The present invention is not limited to the description of the embodiments above, but may be altered by a skilled person within the scope of the claims. An embodiment based on a proper combination of technical means disclosed in different embodiments is encompassed in the technical scope of the present invention.

As described above, the ink ejector of the present invention includes: movement control means for controlling the head to be movable in a direction which is not parallel to a nozzle array; ejection nozzle determination means for determining an ejection nozzle group including a plurality of target nozzles which are successively arranged in the nozzle array and actually eject ink to the medium; ink ejection timing control means for controlling ink ejection so that ink ejection timing is delayed in an order in which the plurality of target nozzles in the ejecting nozzle group eject ink; and ink ejection amount control means for gradually changing an amount of ink to be ejected so that the amount of ink to be ejected is increased in the order in which the plurality of target nozzles in the ejecting nozzle group eject ink.

As described above, the ink ejection control method of the present invention, in which the head is movable in a direction which is not parallel to a nozzle array, includes: determining an ejection nozzle group including a plurality of target nozzles which are successively arranged in the nozzle array and actually eject ink to the medium; controlling ink ejection so that ink ejection timing is delayed in an order in which the plurality of target nozzles in the ejecting nozzle group eject ink; gradually changing an amount of ink to be ejected so that the amount of ink to be ejected is increased in the order in which the plurality of target nozzles in the ejecting nozzle group eject ink.

Since an amount of ink ejected later is larger than an amount of ink ejected earlier, a film thickness of an ink ejection area can be made uniform after ink landing even if the ink ejected later is drawn towards the ink ejected earlier. As a result, it is possible to form a high-quality film.

Further, since the head includes a nozzle array having a plurality of nozzles, it is possible to shorten a restoration time of a defective pixel, as compared with a case where a head having only one nozzle is used. Furthermore, an amount of ink to be ejected from each of the plurality of nozzles can be made smaller.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention can be applied to restoration of a defective pixel(s) generated in a CF panel. Further, the present invention can be applied to manufacturing of an EL display device having a plurality of sections to which ink is ejected and which are arranged in a matrix manner or in a stripe manner. Further, the present invention can be applied to (i) manufacturing of a back substrate of a plasma display device, (ii) manufacturing of an image display device including an electron emitting element, and (iii) manufacturing of wiring.

1. An ink ejector including a head which (i) is movable relative to a medium to which ink is to be ejected and (ii) includes a nozzle array having a plurality of nozzles from which ink can be ejected to the medium, comprising:
movement control means for controlling the head to be movable in a direction which is not parallel to the nozzle array;
ejection nozzle determination means for determining an ejection nozzle group including a plurality of target nozzles which are successively arranged in the nozzle array and actually eject ink to the medium;
ink ejection timing control means for controlling ink ejection so that ink ejection timing is delayed in an order in which the plurality of target nozzles in the ejecting nozzle group eject ink; and
ink ejection amount control means for gradually changing an amount of ink to be ejected so that the amount of ink to be ejected is increased in the order in which the plurality of target nozzles in the ejecting nozzle group eject ink.

2. The ink ejector according to claim 1, further comprising ink ejection area recognition means for recognizing an ink ejection area to which ink is to be actually ejected, wherein:
the ejection nozzle determination means determines, as the ejection nozzle group, a nozzle group including a plurality of nozzles corresponding to the ink ejection area thus recognized, the plurality of nozzles being included in the nozzle array, and
the ink ejection timing control means and the ink ejection amount control means (i) determine, as a first nozzle which first eject ink, a nozzle which first reaches the ink ejection area and (ii) control the ejection timing and a change in amount of ink to be ejected, respectively, in an order in which the first nozzle and its following nozzles are arranged.

3. The ink ejector according to claim 2, wherein:
the ink ejection area recognition means can recognize at least one of shape and size of the ink ejection area, and
the ink ejection amount control means controls the change in amount of ink to be ejected on a basis of information recognized by the ink ejection area recognition means.

4. The ink ejector according to claim 1, wherein the ink ejection amount control means is an ink droplet number calculating section which changes an amount of ink droplets to be ejected so as to gradually change the amount of ink to be ejected.

5. The ink ejector according to claim 1, wherein the movement control means controls the head or the medium to move in a direction tilted with respect to the nozzle array.

6. The ink ejector according to claim 5 further comprising angle adjustment means for adjusting an angle of the head or the medium.

7. The ink ejector according to claim 6, wherein:
the angle adjustment means adjusts the angle of the head or the medium with respect to the nozzle array on a basis of at least one of the shape and the size of the ink ejection area, and functions as the ejection nozzle determination means for determining, as the ejection nozzle group, a nozzle group including a plurality of nozzles corresponding to the ink ejection area on a basis of the angle thus adjusted.

8. The ink ejector according to claim 6, further comprising ink ejection pattern generating means for generating an ink ejection pattern on a basis of at least (i) the angle of the head or the medium which angle is adjusted by the angle adjustment means and (ii) the gradual change in amount of ink to be ejected which change is controlled by the ink ejection amount control means, ink being ejected from the ejection nozzle group on a basis of the ink ejection pattern.

9. The ink ejector according to claim 8, wherein:
the ink ejection timing control means controls the ink ejection timing to be delayed with a use of the ink ejection pattern generated by the ink ejection pattern generating means, and
the head ejects ink in response to a control signal from the ink ejection timing control means and the ink ejection pattern.

10. The ink ejector according to claim 1, wherein the ink ejector is used to restore a defective pixel of a color filter panel for use in a display device.

11. (canceled)

12. An ink ejection control method for controlling ink ejection from a head which (i) is movable relative to a medium to which ink is to be ejected and (ii) includes a nozzle array having a plurality of nozzles from which ink can be ejected to the medium, the head being movable in a direction which is not parallel to the nozzle array, comprising the steps of:
(a) determining an ejection nozzle group including a plurality of target nozzles which are successively arranged in the nozzle array and actually eject ink to the medium;
(b) controlling ink ejection so that an ink ejection timing is delayed in an order in which the plurality of target nozzles in the ejecting nozzle group eject ink; and
(c) gradually changing an amount of ink to be ejected so that the amount of ink to be ejected is increased in the order in which the plurality of target nozzles in the ejecting nozzle group eject ink.

13. The ink ejection control method according to claim 12, further comprising the step of (d) recognizing an ink ejection area to which ink is to be actually ejected, wherein:
in the step (a), a nozzle group including a plurality of nozzles corresponding to the ink ejection area thus recognized is determined as the ejection nozzle group, the plurality of nozzles being included in the nozzle array, and
in the step (b) and (c), (i) a nozzle which first reaches the ink ejection area is determined as a first nozzle which first ejects ink, (ii) the ejection timing and a change in amount of ink to be ejected are controlled, respectively, in an order in which the first nozzle and its following nozzles are arranged.

14. The ink ejection control method according to claim 13, wherein:
in the step (d), at least one of shape and size of the ink ejection area can be recognized, and
in the step (c), the change in amount of ink to be ejected is controlled on a basis of information recognized by the ink ejection area recognition means.

15. The ink ejection control method according to claim 12, wherein
the step (c) is a step (e) in which an amount of ink droplets to be ejected is changed so that the amount of ink to be ejected is gradually changed.

16. The ink ejection control method according to claim 12, wherein
the head or the medium is movable in a direction tilted with respect to the nozzle array.

17. The ink ejection control method according to claim 16 further comprising the step of (f) adjusting an angle of the head or the medium.

18. The ink ejection control method according to claim 17, wherein:
in the step (f), the angle of the head or the medium with respect to the nozzle array is adjusted on a basis of at least one of the shape and the size of the ink ejection area, and the step (f) functions as the step (a) of determining, as the ejection nozzle group, a nozzle group including a plurality of nozzles corresponding to the ink ejection area on a basis of the angle thus adjusted.

19. The ink ejection control method according to claim 17, further comprising the step of
(g) generating an ink ejection pattern on a basis of at least (i) the angle of the head or the medium which angle is adjusted in the step (f) and (ii) the gradual change in amount of ink to be ejected which change is controlled in the step (c),
ink being ejected from the ejection nozzle group on a basis of the ink ejection pattern.

20. The ink ejection control method according to claim 19, wherein:
in the step (b), the ink ejection timing is controlled to be delayed with a use of the ink ejection pattern generated in the step (g), and
the head ejects ink in response to a control signal from the step (b) and the ink ejection pattern.

21. The ink ejection control method according claim 12, wherein
the ink ejection control method is used to restore a defective pixel of a color filter panel for use in a display device.

22. (canceled)
